(19) United States
(12) Patent Application Publication
(10) Pub. No.: US 2008/0182648 A1
(43) Pub. Date: Jul. 31, 2008

(54) SLOT MACHINE AND CONTROL METHOD THEREOF

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/014,290

(22) Filed: Jan. 15, 2008

(30) Foreign Application Priority Data
Jan. 23, 2007 (JP) 2007-012636

(51) Int. Cl. A63F 9/24; A63F 13/08; A63F 13/00

(52) U.S. Cl. 463/21; 463/31; 463/25

(57) ABSTRACT

A slot machine comprises a display including plural slot game areas on each of which a slot game can be executed. A replay is executed on a slot game area when a winning combination has been achieved on another slot game area. According to the slot machine, a new entertaining feature can be provided.

### CROSS-REFERENCE TO RELATED APPLICATION

This application is based upon the prior Japanese Patent Application No. 2007-012636, filed on Jan. 23, 2007, the entire contents of which are incorporated herein by reference.

This application is related to co-pending U.S. patent application entitled “SLOT MACHINE AND PLAYING METHOD THEREOF” referred to as the prior Japanese Patent Application No. 2006-337480, filed in Japan on Dec. 14, 2006, co-pending U.S. patent application entitled “SLOT MACHINE AND PLAYING METHOD THEREOF” referred to as the prior Japanese Patent Application No. 2006-337540, filed in Japan on Dec. 14, 2006, co-pending U.S. patent application entitled “SLOT MACHINE AND PLAYING METHOD THEREOF” referred to as the prior Japanese Patent Application No. 2006-337541, filed in Japan on Dec. 14, 2006, co-pending U.S. patent application entitled “SLOT MACHINE AND PLAYING METHOD THEREOF” referred to as the prior Japanese Patent Application No. 2006-337556, filed in Japan on Dec. 14, 2006, co-pending U.S. patent application entitled “SLOT MACHINE AND PLAYING METHOD THEREOF” referred to as the prior Japanese Patent Application No. 2006-343150, filed in Japan on Dec. 20, 2006, co-pending U.S. patent application entitled “SLOT MACHINE AND PLAYING METHOD THEREOF” referred to as the prior Japanese Patent Application No. 2007-012415, filed in Japan on Jan. 23, 2007, co-pending U.S. patent application entitled “SLOT MACHINE AND CONTROL METHOD THEREOF” referred to as the prior Japanese Patent Application No. 2007-012628, filed in Japan on Jan. 23, 2007, and co-pending U.S. patent application entitled “SLOT MACHINE AND PLAYING METHOD THEREOF” referred to as the prior Japanese Patent Application No. 2007-016391, filed in Japan on Jan. 26, 2007, which are assigned to the assignee of the present invention. The teachings of the co-pending applications are incorporated herein by reference to the extent they do not conflict with the teaching herein.

### BACKGROUND OF THE INVENTION

1. Field of the Invention

The present invention relates to a slot machine and a control method thereof.

2. Description of the Related Art

In a conventional slot machine, a plurality of reels (e.g., three reels) on which a plurality of symbols is drawn spins, respectively, when a player inserts a medal(s) into a medal insertion slot and then presses a start button. The reels stop after a predetermined time has elapsed. At this time, a payout is awarded to the player according to the number of inserted medals if a winning symbol combination achieved on a preset payline. Alternatively, a payout is awarded to the player according to the number of inserted medals if a predetermined number of scatter symbols displayed.

On the other hand, in the gaming machine described in U.S. Pat. No. 6,855,052, a plurality of wheels provided above the reels begins to spin sequentially and then stops if a preset symbol combination has displayed on the reels after the reels has stopped. A large amount payout is awarded if the stopped wheels have brought a predetermined outcome.

### SUMMARY OF THE INVENTION

An object of the present invention is to provide a slot machine and a control method thereof capable of providing a new entertaining feature.

A first aspect of the present invention provides a slot machine which comprises: a slot game in which symbols which have been arranged are rearranged; a first display including plural slot game areas on each of which the slot game is executed; an input device for accepting a betting operation by a player; and a controller. The controller is operable to: (a) activate slot game areas among the plural slot game areas according to the betting operation via the input device, (b) execute a slot game at each of the slot game areas activated in (a), and (c) rearrange, after a winning combination has been achieved in a slot game executed in (b) on one slot game area, a same symbol combination as the winning combination on another slot game area.

According to the first aspect of the present invention, a new entertaining feature is provided in that the replay is executed on the other slot game areas after the winning combination has been achieved in a slot game on the one slot game area.

In addition, since the replay is executed on the other slot game areas, the player can feel greater pleasure for a payout and his/her interest in a slot game is maintained.

It is preferable the other slot game area has mechanical reels, each of which has symbols on its outer circumferential surface. It is also preferable that the controller is operable to produce a predetermined effect while rearranging the same symbol combination on the other slot game area. It is further preferable that the other slot game area has mechanical reels, each of which has symbols on its outer circumferential surface.

A second aspect of the present invention provides a slot machine which comprises: a slot game in which symbols which have been arranged are rearranged; a first display including plural slot game areas on each of which the slot game is executed; an input device for accepting a betting operation by a player; and a controller. The controller is operable to: (a) activate slot game areas among the plural slot game areas according to the betting operation via the input device, (b) execute a slot game at each of the slot game areas activated in (a), and (c) rearrange, after a winning combination has been achieved in a slot game executed in (b) on one slot game area, a same symbol combination as the winning combination on another slot game area. And the other slot game area has mechanical reels, each of which has symbols on its outer circumferential surface.

According to the second aspect of the present invention, a new entertaining feature is provided in that the replay is executed on the other slot game areas after the winning combination has been achieved in a slot game on the one slot game area.

In addition, since the replay is executed on the other slot game areas, the player can feel greater pleasure for a payout and his/her interest in a slot game is maintained.

Furthermore, since the replay is executed by the mechanical reels, the player can receive a stronger impact by the replay than when both a slot game on the one slot game area and a replay on the other slot game areas are executed by the same image display presentation.

A third aspect of the present invention provides a slot machine which comprises: a slot game in which symbols which have been arranged are rearranged; a first display including plural slot game areas on each of which the slot game is executed; a second display provided separately from the first display for displaying an extra slot game; an input device for accepting a betting operation by a player; and a controller. The controller is operable to: (a) activate slot game areas among the plural slot game areas according to the betting operation via the input device, (b) execute a slot game at each of the slot game areas activated in (a), and (c) rearrange, after a winning combination has been achieved in a slot game executed in (b) on one slot game area, a same symbol combination as the winning combination on another slot game area and produce a predetermined effect while rearranging.

According to the third aspect of the present invention, a new entertaining feature is provided in that the replay is executed on the other slot game areas after the winning combination has been achieved in a slot game on the one slot game area.

In addition, since the replay is executed on the other slot game areas, the player can feel greater pleasure for a payout and his/her interest in a slot game is maintained.

Furthermore, since the predetermined effect is produced while the replay is executed on the other slot game areas, the player can feel greater pleasure for a payout and his/her interest in a slot game is maintained also in this point.

A fourth aspect of the present invention provides a slot machine which comprises: a slot game in which symbols which have been arranged are rearranged; a first display including plural slot game areas on each of which the slot game is executed; a second display provided separately from the first display for displaying an extra slot game; an input device for accepting a betting operation by a player; and a controller. The controller is operable to: (a) activate slot game areas among the plural slot game areas according to the betting operation via the input device, (b) execute a slot game at each of the slot game areas activated in (a), and (c) rearrange, after a winning combination has been achieved in a slot game executed in (b) on one slot game area, a same symbol combination as the winning combination on another slot game area and produce a predetermined effect while rearranging. And the other slot game area has mechanical reels, each of which has symbols on its outer circumferential surface.

According to the fourth aspect of the present invention, a new entertaining feature is provided in that the replay is executed on the other slot game areas after the winning combination has been achieved in a slot game on the one slot game area.

In addition, since the replay is executed on the other slot game areas, the player can feel greater pleasure for a payout and his/her interest in a slot game is maintained.

Furthermore, since the replay is executed by the mechanical reels, the player can receive a stronger impact by the replay than when both a slot game on the one slot game area and a replay on the other slot game areas are executed by the same image display presentation.

Furthermore, since the predetermined effect is produced while the replay is executed on the other slot game areas, the player can feel greater pleasure for a payout and his/her interest in a slot game is maintained also in this point.

A fifth aspect of the present invention provides a control method of a slot machine for playing a slot game in which symbols which have been arranged are rearranged. The slot machine has plural slot game areas on a first display. The slot game can be executed on each of the plural slot game areas. The method comprising: (a) accepting a bet amount from a player, (b) activate slot game areas among the plural slot game areas according to the bet amount accepted in (a), (c) executing a slot game on each of the slot game areas activated in (b), and (d) rearranging, after a winning combination has been achieved in a slot game executed in (b) on one slot game area, a same symbol combination as the winning combination on another slot game area.

According to the fifth aspect of the present invention, a new entertaining feature is provided in that the replay is executed on the other slot game areas after the winning combination has been achieved in a slot game on the one slot game area.

In addition, since the replay is executed on the other slot game areas, the player can feel greater pleasure for a payout and his/her interest in a slot game is maintained.

A sixth aspect of the present invention provides a control method of a slot machine for playing a slot game in which symbols which have been arranged are rearranged. The slot machine has plural slot game areas on a first display. The slot game can be executed on each of the plural slot game areas. The method comprising: (a) accepting a bet amount from a player, (b) activate slot game areas among the plural slot game areas according to the bet amount accepted in (a), (c) executing a slot game on each of the slot game areas activated in (b), and (d) rearranging, after a winning combination has been achieved in a slot game executed in (b) on one slot game area, a same symbol combination as the winning combination on another slot game area. And the other slot game area has mechanical reels, each of which has symbols on its outer circumferential surface.

According to the sixth aspect of the present invention, a new entertaining feature is provided in that the replay is executed on the other slot game areas after the winning combination has been achieved in a slot game on the one slot game area.

In addition, since the replay is executed on the other slot game areas, the player can feel greater pleasure for a payout and his/her interest in a slot game is maintained.

Furthermore, since the replay is executed by the mechanical reels, the player can receive a stronger impact by the replay than when both a slot game on the one slot game area and a replay on the other slot game areas are executed by the same image display presentation.

A seventh aspect of the present invention provides a control method of a slot machine for playing a slot game in which symbols which have been arranged are rearranged. The slot machine has plural slot game areas on a first display. The slot game can be executed on each of the plural slot game areas. The method comprising: (a) accepting a bet amount from a player, (b) activate slot game areas among the plural slot game areas according to the bet amount accepted in (a), (c) executing a slot game on each of the slot game areas activated in (b), and (d) rearranging, after a winning combination has been achieved in a slot game executed in (b) on one slot game area, a same symbol combination as the winning combination on another slot game area and producing a predetermined effect while rearranging.

According to the seventh aspect of the present invention, a new entertaining feature is provided in that the replay is executed on the other slot game areas after the winning combination has been achieved in a slot game on the one slot game area.

In addition, since the replay is executed on the other slot game areas, the player can feel greater pleasure for a payout and his/her interest in a slot game is maintained.

Furthermore, since the predetermined effect is produced while the replay is executed on the other slot game areas, the player can feel greater pleasure for a payout and his/her interest in a slot game is maintained also in this point.

An eighth aspect of the present invention provides a control method of a slot machine for playing a slot game in which symbols which have been arranged are rearranged. The slot machine has plural slot game areas on a first display. The slot game can be executed on each of the plural slot game areas. The method comprising: (a) accepting a bet amount from a player, (b) activate slot game areas among the plural slot game areas according to the bet amount accepted in (a), (c) executing a slot game on each of the slot game areas activated in (b), and (d) rearranging, after a winning combination has been achieved in a slot game executed in (b) on one slot game area, a same symbol combination as the winning combination on another slot game area and producing a predetermined effect while rearranging. And the other slot game area has mechanical reels, each of which has symbols on its outer circumferential surface.

According to the eighth aspect of the present invention, a new entertaining feature is provided in that the replay is executed on the other slot game areas after the winning combination has been achieved in a slot game on the one slot game area.

In addition, since the replay is executed on the other slot game areas, the player can feel greater pleasure for a payout and his/her interest in a slot game is maintained.

Furthermore, since the replay is executed by the mechanical reels, the player can receive a stronger impact by the replay than when both a slot game on the one slot game area and a replay on the other slot game areas are executed by the same image display presentation.

Furthermore, since the predetermined effect is produced while the replay is executed on the other slot game areas, the player can feel greater pleasure for a payout and his/her interest in a slot game is maintained also in this point.

### BRIEF DESCRIPTION OF THE DRAWINGS

FIG. 1 is an explanatory diagram showing eleven slot game areas displayed on an LCD in an embodiment of a slot machine of the present invention;

FIG. 2 is a perspective view of the slot machine of the embodiment of the present invention;

FIG. 3 is an explanatory diagram showing one of the slot game areas in the slot machine of the embodiment;

FIG. 4 is an explanatory diagram showing paylines on the slot game area;

FIG. 5 is an explanatory diagram showing a payout table for slot games;

FIG. 6 is an explanatory diagram showing the slot game areas displayed on the LCD panel;

FIG. 7 is an explanatory diagram showing the slot game areas displayed on the LCD panel;

FIG. 8 is a block diagram showing a control circuit of the slot machine of the embodiment;

FIG. 9 is a flowchart showing a processing procedure (main processing) in the slot machine of the first embodiment; and

FIG. 10 is a flowchart showing a processing procedure (slot game execution processing) in the slot machine of the embodiment.

### DETAILED DESCRIPTION OF THE EMBODIMENT

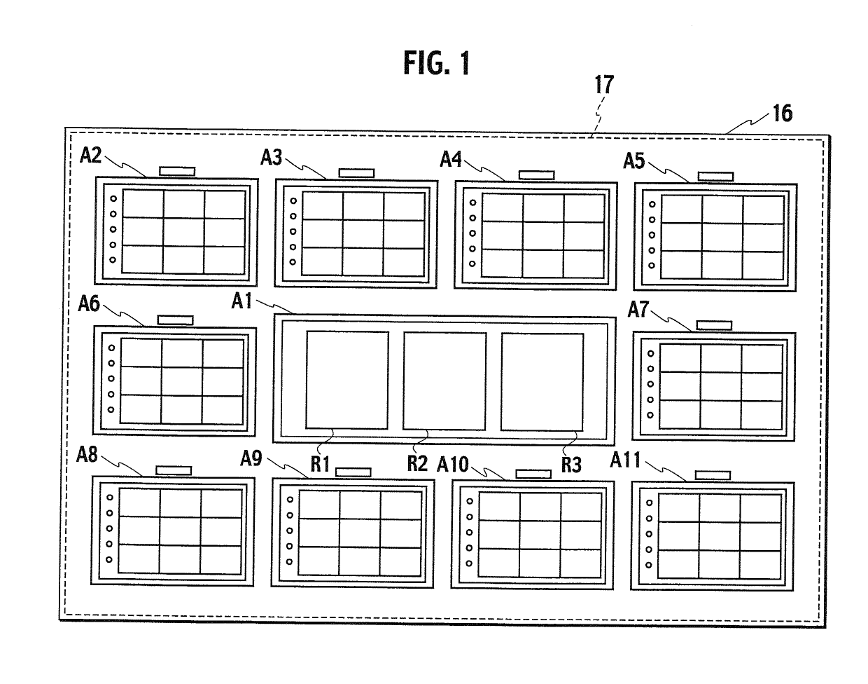

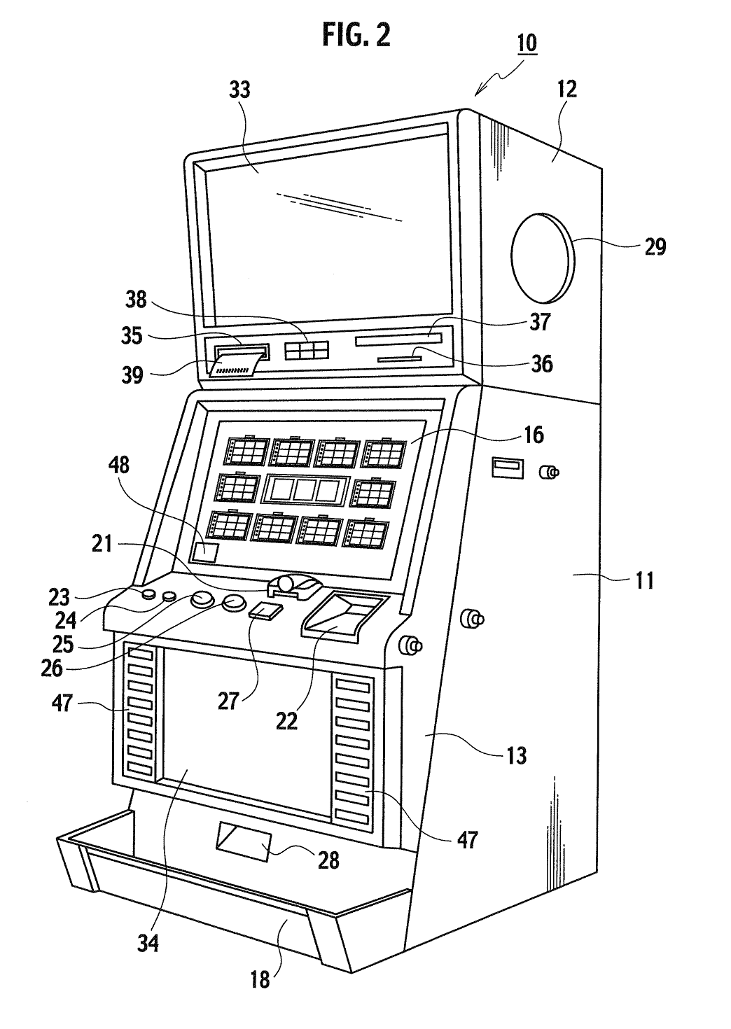

An embodiment of the present invention will be described below with reference to FIG. 1 and FIG. 2. FIG. 1 illustrates an exemplary display on a liquid crystal display (LCD: a display) 16 of a slot machine 10 of the present embodiment. As shown in FIG. 1, the LCD 16 has nine slot game areas A1 to A11 (simply referred to as “areas”, hereinafter). A slot game is executed on each of the areas A1 to A11.

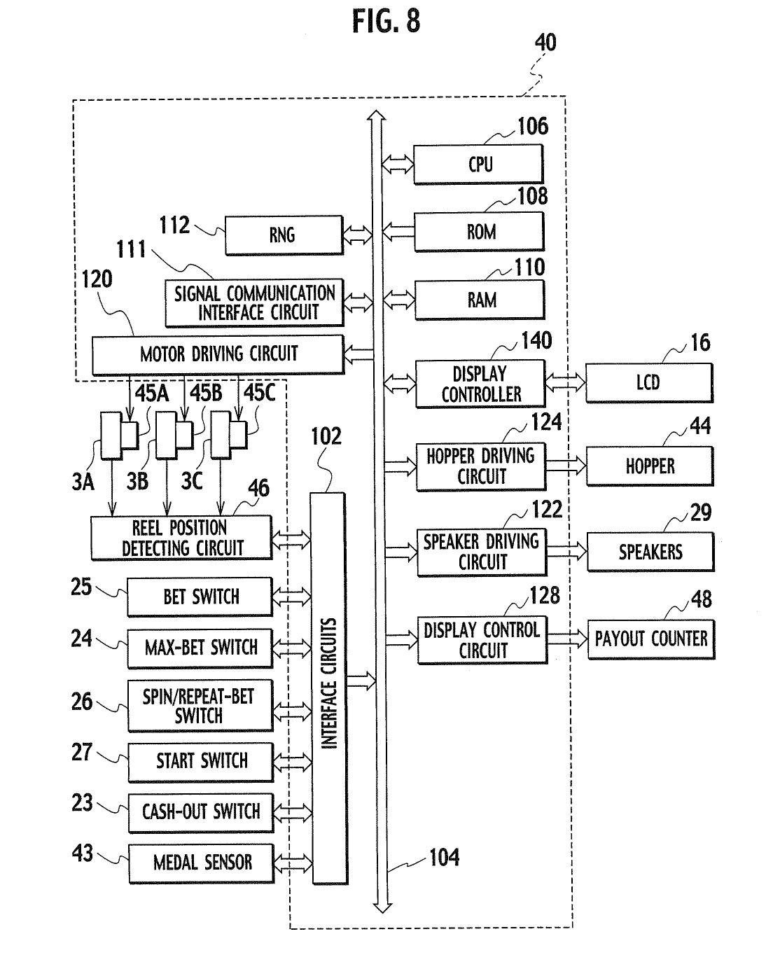

The area A11 has display windows R1 to R3 aligned laterally as a single row. A mechanical reel 3A (FIG. 8) is provided behind the display window R1. A plurality of symbols is drawn on the circumferential surface of the reel 3A. The circumferential surface faces the display window R1. When the reel 3A stops, a symbol comes to a stop (arranged) within the display window R1. When the reel 3A spins, the symbol scrolls within the display window R1. Subsequently, when the reel 3A stops again, a symbol comes to a stop (rearranged) within the display window R1. A mechanical reel 3B is provided behind the display window R2 and a mechanical reel 3C is provided behind the display window R3. The display windows R2 and R3 are similar to the display window R1, and the reels 3B and 3C are similar to the reel 3A. The display windows R1 to R3 will be referred to as the display areas R1 to R3 for displaying symbols, hereinafter. Scrolling or stopping of symbols behind the display windows R1 to R3 will be referred to as scrolling or stopping on the display areas R1 to R3, hereinafter.

When a bet is placed on the area A1, the area A1 is activated. Subsequently, symbols are scrolled simultaneously behind the display windows R1 to R3 by spinning the reels 3A to 3C when the start switch 27 has been pressed. And then, the scrolling is finished to stop (rearrange) the symbols at the same time to display symbol in each of the display windows R1 to R3. A payout is awarded to the player when a winning combination has been achieved on the area A1.

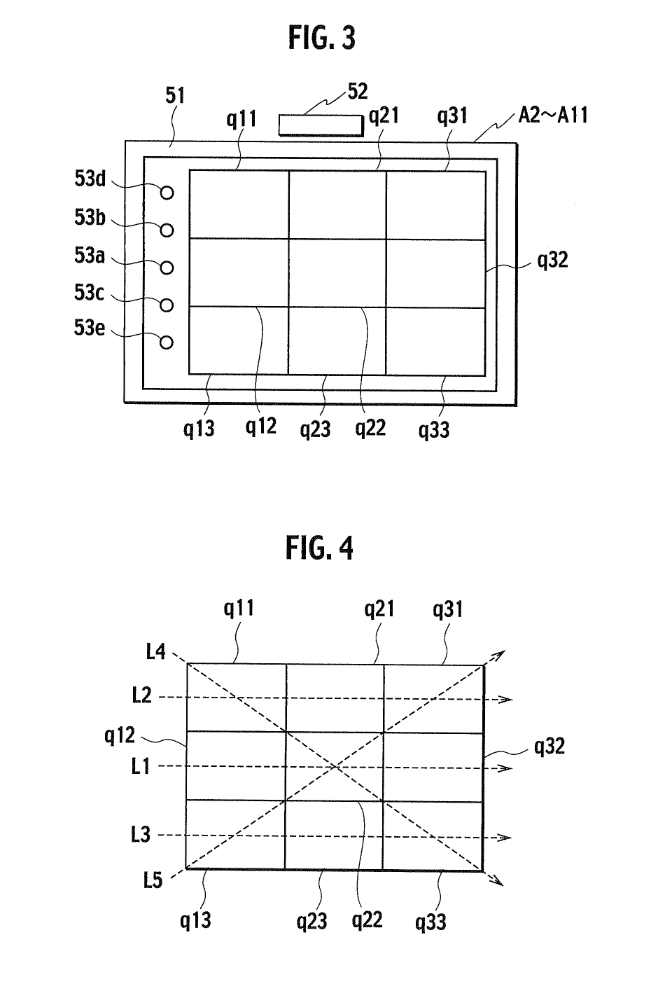

Otherwise, each of the areas A2 to A11 has nine (three rows by three columns) display areas q11 to q33 (FIG. 3). When a bet is placed on any of the areas A2 to A11, the area on which the bet has been placed is activated. Subsequently, symbols displayed (arranged) on display areas q11 to q33 of the activated area(s) are scrolled simultaneously when the start switch 27 has been pressed. And then, the scrolling is finished to stop (rearrange) the symbols at the same time. A payout is awarded to the player when a winning combination has been achieved on any of the paylines of the activated area.

Thus, the slot game is a game in which arranged symbols is rearranged for determining whether or not a payout is awarded according to rearranged symbols.

Here, an example is described in which symbols are scrolled in each slot game and then the symbols are stopped. However, displaying method of the symbols is not limited to scrolling. For example, new symbols may be stopped (rearranged) after each of the symbols in the display areas is switched over successively.

As shown in FIG. 2, the slot machine 10 includes a cabinet 11 and a top box 12 provided on top of the cabinet 11. The cabinet 11 has a main door 13. An upper display 33 is provided on the front of the top box 12 facing the player. The LCD 16 is disposed on the front of the cabinet 11 facing the player. Various component devices are disposed within the cabinet 11, such as a controller 40 (FIG. 8) for electrically controlling the slot machine 10 and a hopper 44 (FIG. 8) for controlling the insertion, pooling, and payout of medals.

In the present embodiment, medals are used for gaming media at game play. However, gaming media is not limited to medals only. For example, coins, tokens, electronic money, or other equivalent electronic value information may be also used as gaming media.

The main door 13 is attached to the cabinet 11 so that it can be opened and closed. The LCD 16 is disposed on an upper portion of the main door 13. The eleven areas A1 to A11 are provided on the LCD 16 and a slot game is executed on each of the slot game areas A1 to A11. In the present embodiment, the number of slot game areas on the LCD 16 is eleven. However, two or more slot game areas may be provided.

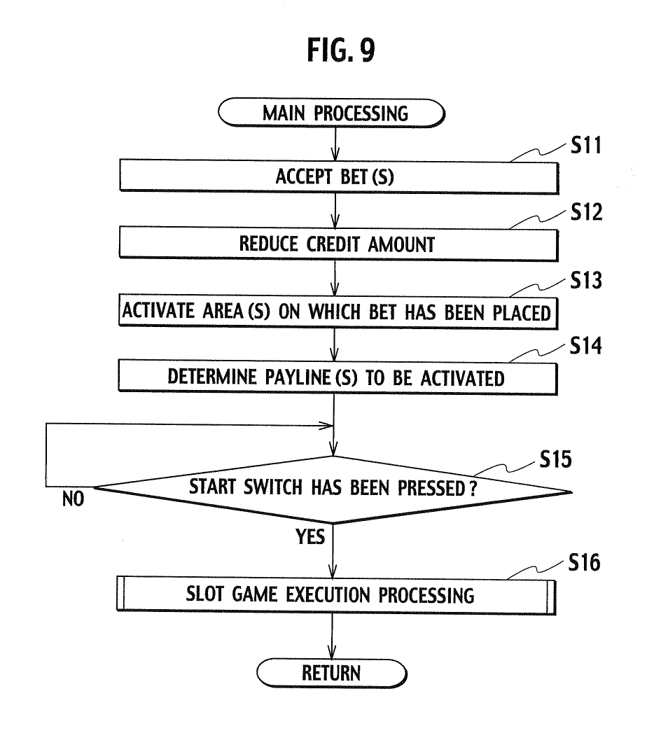

A payout counter 48 for displaying a total credit amount is provided in a bottom left area of the LCD 16. The total credit amount is a sum of medals awarded to the player and is stored in a RAM 110 (FIG. 9).

A medal insertion slot 21 and a bill validator 22 are disposed below the LCD 16. The bill validator 22 validates bills and accepts valid ones. Various operational switches are disposed nearby the medal insertion slot 21 and the bill validator 22.

A cash-out switch 23, a max-bet switch (input device) 24, a bet switch (input device) 25, a spin/repeat-bet switch (input device) 26, and the start switch 27 are provided as the operational switches.

A bet amount is input by the player via the bet switch 25. Specifically, the bet switch 25 is a switch for determining a bet amount on each slot game on the areas A1 to A11. As will be described later, each time the bet switch 25 is pressed, one bet is placed on any one of the areas A1 to A11. The slot game area on which a bet has been placed is activated and a payout is provided to the player when a winning symbol combination has been achieved on a payline on the activated area.

A bet amount can be input by the player via the spin/repeat-bet switch 26. The spin/repeat-bet switch 26 is a switch for placing a bet again without changing a bet amount placed by the bet switch 25 (and the max-bet switch 24) on the previous game on each of the areas A1 to A9 and starting a slot game on each of the areas A1 to A9.

The start switch 27 is a switch for starting a slot game on each of the areas A1 to A11 after bets have been placed on desired areas. A slot game on each of the areas A1 to A11 is started simultaneously after a medal(s) was inserted into the medal insertion slot 21 or a bet(s) was placed by the bet switch 25 and the start switch 27 has been pressed.

The cash-out switch 23 is a switch for cashing out medals corresponding to the total credit amount. The medals are cashed out from a medal cash-out chute 28 opened in the front lower part of the main door 13 and pooled on a medal tray 18.

A bet amount can be input by the player via the max-bet switch 24. Specifically, the max-bet switch 24 is a switch for placing a 3-credit bet on each of all the area A1 to A11 by one pressing. In the present embodiment, a 3-credit bet is a maximum bet on each of the areas A1 to A11. A maximum bet on each of the areas A1 to A11 may not be limited to a 3-credit bet.

A foot display 34 is disposed on the lower front of the main door 13. Various images relating to the game of the slot machine 10 (such as characters of the slot machine 10) are displayed on the foot display 34.

Lamps 47 are provided on both sides of the foot display 34 and illuminate in a preset illuminating pattern. The medal cash-out chute 28 is provided below the foot display 34.

The upper display 33 is disposed on the front of the top box 12. The upper display 33 has a display panel and displays a payout table indicating each payout amount for each symbol combination etc.

Speakers 29 are provided on the top box 12. A ticket printer 35, a card reader 36, a data display 37, and a keypad 38 are disposed below the upper display 33. The ticket printer 35 prints out a ticket 39 including data such as a credit amount, time and date, identification number of the slot machine 10 printed thereon as a bar code.

The player can play a game at another slot machine by using the bar-coded ticket 39, and exchange the bar-coded ticket 39 for bills at a predetermined site in an amusement facility (e.g. a cashier in the casino).

A smart card can be inserted into the card reader 36 and the card reader 36 reads data from the inserted smart card and writes data onto the smart card. The smart card is carried by the player and stores the player's identification data and gaming history data of the games played by the player.

Next, images displayed on the areas A2 to A11 are explained with reference to FIG. 3. FIG. 3 is a display example of the areas A2 to A11.

As shown in FIG. 3, the nine (three row by three column) display areas q11 to q33 are provided on each of the areas A2 to A11. Symbols are scrolled simultaneously in each of the columns of the display areas q11 to q33 when the slot game is started on each of the areas A2 to A11 by pressing the start switch 27.

Five LEDs 53a to 53e are provided on the left side of the display areas q11 to q33 of each of the areas A2 to A11. The LEDs 53a to 53e notify the activated payline(s) on each of the areas A2 to A11. As shown in FIG. 4, five paylines are prepared on the display areas q11 to q33. A horizontal line in the middle row is L1, a horizontal line in the upper row is L2, a horizontal line in the lower row is L3, a diagonal line going down to the right is L4, and a diagonal line going up to the right is L5.

The LEDs 53a to 53e light up according to a bet amount. In detail, only the LED 53a lights up when one credit is bet. The LEDs 53b, 53c, in addition to the LED 53a, light up when two credits are bet. The LEDs 53d, 53e, in addition to the LEDs 53a to 53c, light up when three credits are bet.

It is indicated that the line L1 has been activated, when the LED 53a lights up. In addition, it is indicated that the lines L2, L3 have been activated, respectively, when the LEDs 53b, 53c light up. Furthermore, it is indicated that the lines L4, L5 have been activated, respectively, when the LEDs 53d, 53e light up. As a result, only the line L1 is activated when one credit has been bet, the lines L1, L2, and L3 are activated when two credits have been bet, and all of the lines L1 to L5 are activated when three credits have been bet. Then, a payout is awarded according to a winning combination(s) when the winning combination(s) is achieved on the activated payline(s). Note that, only one payline along the display windows R1 to R3 is provided on the area A1 regardless of a bet amount on the area A1.

An activation indicating frame 51 is provided on each peripheral edge of the areas A2 to A11. Each of the activation indicating frames 51 lights up for the activated areas A2 to A9. The activation indicating frame 51 lights up on the areas A1 to A9 on which at least one credit is bet. It is possible for a player to easily recognize the activated area(s) by the activation indicating frame(s) 51.

A payout indicator 52 is provided above each of the areas A2 to A11. The payout indicator 52 of each of the areas A2 to A11 lights up when a payout is awarded according to a slot game on that very area. It is possible for a player to easily recognize the area(s) on which a payout is awarded by the bonus game indicator(s) 52.

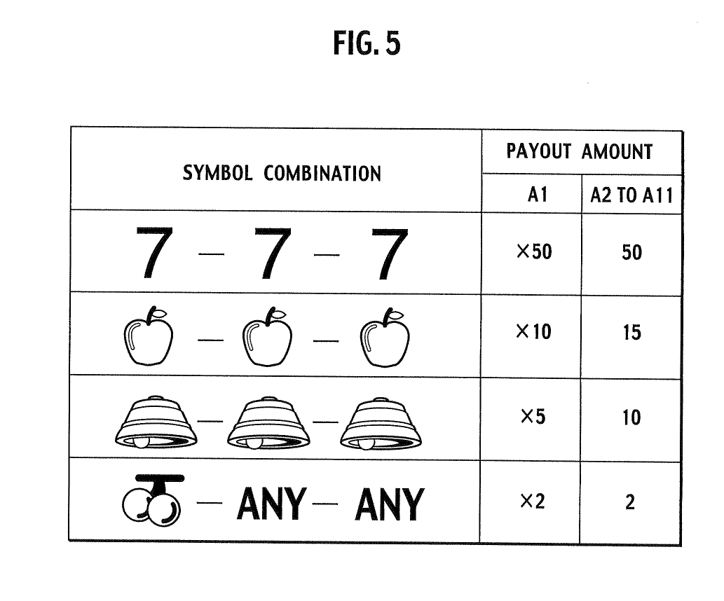

FIG. 5 shows a payout table. The payout table shows relationships between winning combinations and payout rates and relationships between winning combinations and payout amounts. In the present embodiment, winning combinations are a symbol combination of three 7's, a symbol combination of three BELLs, and a symbol combination including a left-most CHERRY on a payline. The payout rates are defined for a slot game (replay) on the area A1. The payout amount are defined for a slot game on each of the areas A2 to A11.

Specifically, in respect to a slot game (replay) on the area A1, a payout is awarded to the player as follows. A payout amount fifty times as much as a bet amount on the area A1 is awarded to the player if three 7's are achieved. A payout amount ten times as much as a bet amount on the area A1 is awarded to the player if three APPLEs are achieved. A payout amount five times as much as a bet amount on the area A1 is awarded if three BELLs are achieved. A payout amount twice as much as a bet amount on the area A1 is awarded if a CHERRY comes to a stop in the display window R1.

Otherwise, in respect to a slot game on each of the areas A2 to A11, a payout is awarded to the player as follows. A 50-credit payout is awarded to the player if the line L1 (FIG. 4) is activated and three 7's are achieved on the payline L1. A 15-credit payout is awarded to the player if three APPLEs are achieved on the activated payline L1. A 10-credit payout is awarded if three BELLs are achieved on the activated payline L1. A 2-credit payout is awarded if a CHERRY comes to a stop in the display area q12 on the activated payline L1.

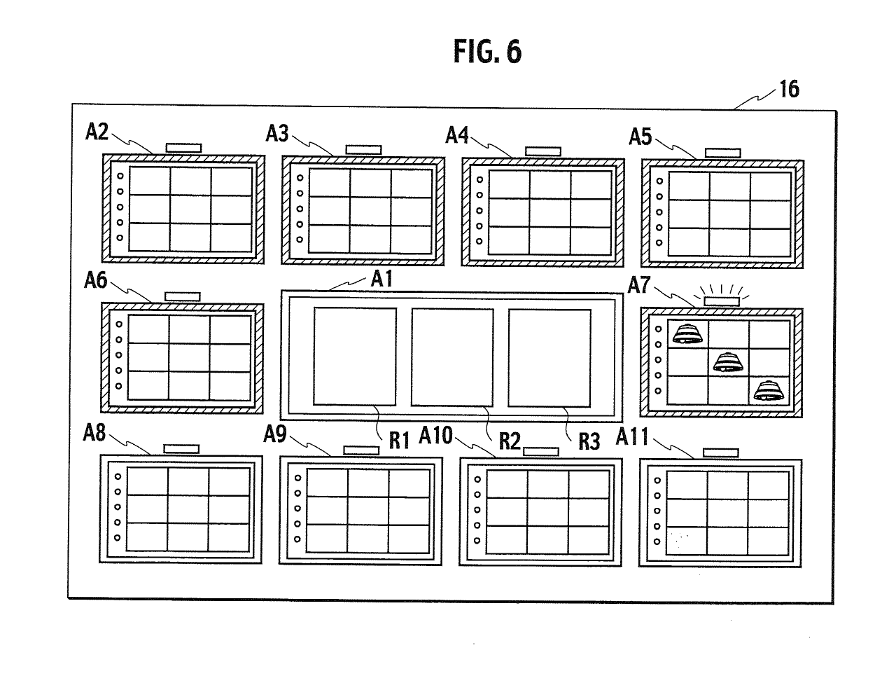

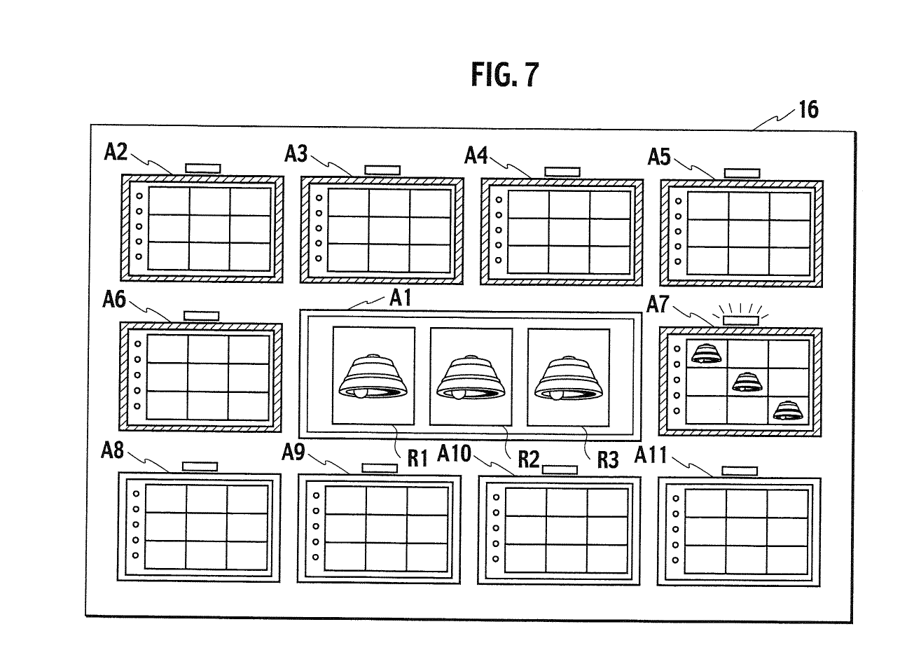

In the present embodiment, if a winning combination has been achieved on a activated payline of the active areas A2 to A11, an identical winning combination is going to be rearranged on the area A1. In other words, a replay is executed on the area A1. For example, if a three BELLs winning combination has achieved on the activated payline of the area A7 as shown in FIG. 6, the reels 3A to 3C start spinning. And then, the reels 3A to 3C stop spinning and a three BELLs winning combination is achieved behind the display windows R1 to R3, as shown in FIG. 7. Here, if a winning combination has been achieved on plural activated areas, plural replays are executed in the ascending order of the area number. For example, if a winning combination has been achieved on the areas A2 and A6, the reels 3A to 3C spin and then stop spinning to achieve the same winning combination on the area A1 as the winning combination on the area A2. Subsequently, the reels 3A to 3C spin again and then stop spinning to achieve the same winning combination on the area A1 as the winning combination on the area A6.

FIG. 8 is a block diagram illustrating the electric configuration of the controller 40 and various components connected to the controller 40, which are provided within the slot machine 10 of the present embodiment. The controller 40 of the slot machine 10 is a microcomputer and includes interface circuits 102, an input/output (I/O) bus 104, a CPU 106, a ROM 108, a RAM 110, a signal communication interface (I/F) circuit 111, a motor drive circuit 120, a random number generator (RNG) 112, a speaker drive circuit 122, a hopper drive circuit 124, a display control circuit 128, and a display controller 140.

The interface circuits 102 are connected to the I/O bus 104. The I/O bus 104 inputs/outputs data signals and address signals to/from the CPU 106.

The start switch 27 is connected to the interface circuits 102. A start signal output from the start switch 27 is transmitted to the CPU 106 via the I/O bus 104, after having been converted into a predetermined signal by the interface circuits 102.

The bet switch 25, the max-bet switch 24, the spin/repeat-bet switch 26, and the cash-out switch 23 are connected to the interface circuits 102. A switching signal output from each of the switches 23 to 26 is transmitted to the CPU 106 via the I/O bus 104, after having been converted into a predetermined signal by the interface circuits 102.

A medal sensor (input device) 43 is connected to the interface circuits 102. Abet amount by the player's inserting a medal(s) can be detected via the medal sensor 43. The medal sensor 43 detects a medal(s), which has been inserted into the medal insertion slot 21. The medal sensor 43 is provided inside the medal insertion slot 21. The detection signal output from the medal sensor 43 is transmitted to the CPU 106 via the I/O bus 104, after having been converted into a predetermined signal by the interface circuits 102.

A reel position detecting circuit 46 is connected to the interface circuits 102. The reel position detecting circuit 46 detects each current spinning or stopped position of the reels 3A to 3C. The detection signal output from the reel position detecting circuit 46 is transmitted to the CPU 106 via the I/O bus 104.

The ROM 108 storing system programs and the payout table, and the RAM 110 storing various data are connected to the I/O bus 104. The RNG 112, the signal communication I/F circuit 111, the motor drive circuit 120, the display controller 140, the hopper drive circuit 124, the speaker drive circuit 122, and the display control circuit 128 are connected to the I/O bus 104.

The CPU 106, triggered by receiving the start signal from the start switch 27, reads a game execution program among the system programs and executes a game. The game execution program is a program for executing the slot game in each of the areas A1 to A11 on the LCD 16 using the display controller 140.

In other words, the game execution program is programmed so as to execute a slot game in which symbols are rearranged after scrolling simultaneously on each of the areas A1 to A11 and a payout is provided when a winning combination is achieved on an activated payline.

The signal communication I/F circuit 111, which is connected to a hall server etc., transmits gaming history data etc. of the slot machine 10 to the hall server. The signal communication I/F circuit 111 receives various data transmitted from the hall server.

The RNG 112 generates a random number for determining whether or not to achieve a winning combination in the slot game on each of the areas A1 to A11.

Motors 45A to 45C are connected to the motor driving circuit 120. The motor 45A spins the reel 3A and stops the spinning reel 3A. The motor 45B spins the reel 3B and stops the spinning reel 3B. The motor 45C spins the reel 3C and stops the spinning reel 3C. The motor driving circuit 120 is controlled by the CPU 106 to drive the reels 3A to 3C.

The display control circuit 128 controls displaying the total credit amount on the payout counter 48 provided at the lower left area of the LCD 16.

The speaker drive circuit 122 outputs sound data to the speakers 29. In other words, the CPU 106 reads the sound data stored in the ROM 108 and transmits the sound data to the speaker drive circuit 122 via the I/O bus 104. In this manner, predetermined sound effects are generated via the speakers 29.

The hopper drive circuit 124 outputs a cash-out signal to the hopper 44 when providing a cash-out. In other words, the CPU 106 outputs a drive signal to the hopper drive circuit 124 via the I/O bus 104 when receiving the cash-out signal from the cash-out switch 23. As a result, the hopper 44 cashes out medals equivalent to the total credit amount.

The display controller 140 controls the execution of the slot game on each of the areas A2 to A11. In detail, the CPU 106 generates an image display signal according to status and an outcome of the slot game on each of the areas A2 to A11 and outputs the image display signal to the display controller 140 via the I/O bus 104. Upon receipt of the image display signal, the display controller 140 generates a drive signal of the LCD 16 based on the image display signal. And then, the display controller 140 outputs the drive signal to the LCD 16. In this manner, the predetermined images are displayed on the LCD 16.

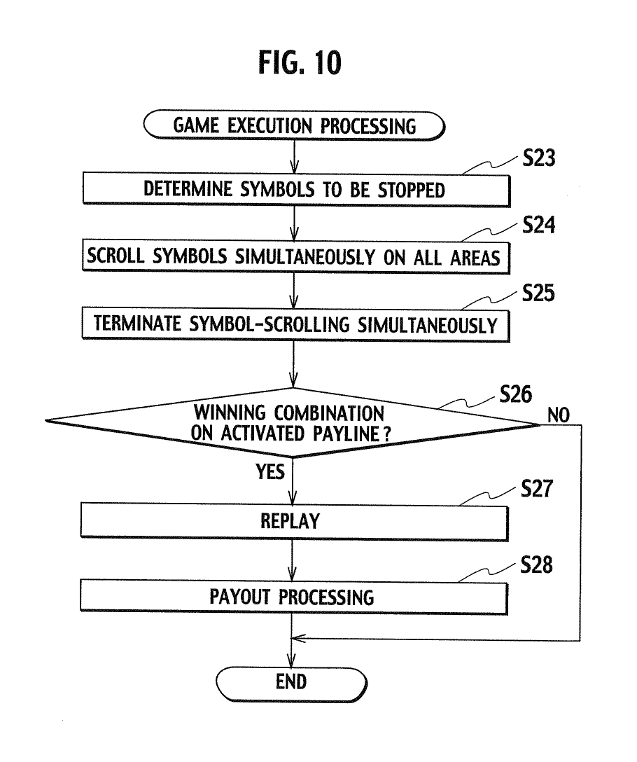

Next, an operation of the slot machine of the present embodiment is described with reference to flowcharts shown in FIG. 9 and FIG. 10. FIG. 9 is a flowchart showing a main processing.

A player places a bet with a desired bet amount on a slot game on each of the areas A1 to A11 by pressing the max-bet switch 24, the bet switch 25, or the spin/repeat-bet switch 26 (step S11). Alternatively, the player places a bet by inserting a desired number of medals into the medal insertion slot 21. In the present embodiment, a bet is placed preferentially on a slot game (replay) on the area A1. And then, each bet is placed on a slot game on each of the areas A2 to A11 in an ascending order of the area numbers. For example, when 20 credits are bet, the 1st to 3rd credits are bet on a slot game on the area A1, and the 4th to 13th credits are bet as a 1st-bet on a slot game on each of the areas A2 to A11, and the 14th to 20th credits are bet as a 2nd-bet on the slot game on each of the areas A2 to A8. Thus, three credits are bet on the area A1, two credits are bet on the areas A2 to A8 and one credit is bet on the areas A9 to A11.

The CPU 106 (FIG. 8) subtracts the credit(s) corresponding to the bet amount from the total credit amount when a bet(s) is placed by pressing the max-bet switch 24, the bet switch 25, or the spin/repeat-bet switch 26 (step S12). For example, if 27 credits are bet when the total credit amount is 50 credits, the total credit amount becomes 50−27=23 credits.

Next, the CPU 106 activates the area(s) on which a bet has been placed (step S13).

The CPU 106 determines payline(s) to be activated on the activated area(s) (step S14). As described above, only one payline along the display windows R1 to R3 is provided on the area A1 regardless of a bet amount on the area A1. On the areas A2 to A11, the line L1 (FIG. 4) is activated when a 1-credit bet has been placed, the lines L1, L2 and L3 are activated when a 2-credit bet has been placed, and all of the lines L1 to L5 are activated when a 3-credit bet has been placed. The CPU 106 lights up the activation indicating frame(s) 51 of the activated area(s) to notify the player.

Subsequently, the CPU 106 determines whether or not the start switch 27 has been pressed (step S15). If the start switch 27 has been pressed, a slot game execution processing (FIG. 10) is executed for the activated area(s) (step S16).

Next, the slot game execution processing executed for the activated area(s) will be described with reference to FIG. 10.

The CPU 106 first determines symbols to be stopped in each display area R1 to R3 and q11 to q33 of the areas A1 to A11 (step S23).

Subsequently, the CPU 106 scrolls symbols simultaneously in each of the display areas R1 to R3 of the area A1 and in each column of the display areas q11 to q33 of the areas A2 to A11 (step S24).

Then scrolling symbols is terminated at the same time after a predetermined time has elapsed (step S25) and symbols come to a stop in each of the display areas R1 to R3 and q11 to q33 on all of the areas A1 to A11. The stopped symbols were the symbols determined in step S23. The CPU 106 lights up the payout indicator(s) 52 of the area(s) on which a winning combination has been achieved on the activated payline.

Then, the CPU 106 determines whether or not a winning combination has been achieved on the activated payline (step S26). If a winning combination has been achieved (step S26: YES), the CPU 106 advances the processing flow to step S27 and otherwise terminates the slot game execution processing without awarding a payout.

If step S26 is affirmative, the CPU 106 executes a replay(s) on the area A1 (step S27). Here, the CPU 106 scrolls symbols in each of the display areas R1 to R3 to achieve the same winning combination as the winning combination had been achieved on any one of the winning activated areas. The replay(s) is executed in this manner. Here, if a winning combination has been achieved on plural activated areas, plural replays are executed in the ascending order of the area number. In addition, the CPU 106 outputs special music (predetermined effect) from the speaker 29 to indicate the execution of the replay(s). Here, the predetermined effect is not limited to the effect of this embodiment. For example, the predetermined effect may be emitting laser beam toward hall ceiling from the top of the slot machine 10, or may be vibrating the slot machine 10.

Next, the CPU 106 executes a payout processing for awarding a payout to the player (step S28). If winning combinations have been achieved on plural activated areas, the CPU 106 provides a payout to the player in a lump sum according to the winning combinations. Here, there are cases such that medals corresponding to a payout amount are cashed out from the cash-out chute 28 and that credits corresponding to a payout amount are added to the total credit amount. Then the CPU 106 terminates the processing.

As described above, according to the slot machine 10, a new entertaining feature is provided in that a replay(s) is executed on the area A1 if a payout is awarded with regard to any of the areas A2 to A11.

Furthermore, according to the slot machine 10, since the replay(s) is executed, a player can feel greater pleasure for a payout and his/her interest in a slot game is maintained.

Particularly, according to the slot machine 10, since a replay(s) is executed also when a payout is awarded with regard to the area A1, the player can feel great pleasure for a payout and his/her interest in the slot game is maintained in this point.

Furthermore, according to the slot machine 10, since a replay(s) is executed by the mechanical reels 3A to 3C, the player can receive a stronger impact by the replay(s) than when a replay(s) is executed on an LCD (e.g., when a replay(s) is executed on any of the areas A2 to A11).

Furthermore, according to the slot machine 10, since a predetermined effect is produced when a replay(s) is executed, the player can feel great pleasure for a payout also in this point.

Therefore, the player can place bets on plural slot games in a lump and then slot games are executed on the slot game areas individually. Thus, according to the slot machine 10, a player can relief from a cumbersome betting operation compared with a conventional slot machine in which a player has to place a bet on a slot game one by one.

The slot machine or the control method of the slot machine of the present invention has been described based on the embodiment. However, the present invention is not limited to the embodiment. Arrangement of respective components of the present invention may be replaced by any components having similar functionalities. For example, in the above described embodiment, a replay is always executed when a winning combination has been achieved. However, a replay may be executed only when a payout amount exceeds a predetermined amount (e.g., only when a three 7's winning combination has been achieved).

What is claimed is:

1. A slot machine comprising:
a slot game in which symbols which have been arranged are rearranged;
a first display including plural slot game areas on each of which the slot game is executed;
an input device for accepting a betting operation by a player; and
a controller operable to:
(a) activate slot game areas among the plural slot game areas according to the betting operation via the input device,
(b) execute a slot game at each of the slot game areas activated in (a), and
(c) rearrange, after a winning combination has been achieved in a slot game executed in (b) on one slot game area, a same symbol combination as the winning combination on another slot game area.

2. The slot machine according to claim 1, wherein
the other slot game area has mechanical reels, each of which has symbols on its outer circumferential surface.

3. The slot machine according to claim 1, wherein
the controller is operable to produce a predetermined effect while rearranging the same symbol combination on the other slot game area.

4. The slot machine according to claim 3, wherein
the other slot game area has mechanical reels, each of which has symbols on its outer circumferential surface.

5. A slot machine comprising:
a slot game in which symbols which have been arranged are rearranged;
a first display including plural slot game areas on each of which the slot game is executed;
an input device for accepting a betting operation by a player; and
a controller operable to:
(a) activate slot game areas among the plural slot game areas according to the betting operation via the input device,
(b) execute a slot game at each of the slot game areas activated in (a), and
(c) rearrange, after a winning combination has been achieved in a slot game executed in (b) on one slot game area, a same symbol combination as the winning combination on another slot game area,
wherein the other slot game area has mechanical reels, each of which has symbols on its outer circumferential surface.

6. A slot machine comprising:
a slot game in which symbols which have been arranged are rearranged;
a first display including plural slot game areas on each of which the slot game is executed;
an input device for accepting a betting operation by a player; and
a controller operable to:
(a) activate slot game areas among the plural slot game areas according to the betting operation via the input device,
(b) execute a slot game at each of the slot game areas activated in (a), and
(c) rearrange, after a winning combination has been achieved in a slot game executed in (b) on one slot game area, a same symbol combination as the winning combination on another slot game area and produce a predetermined effect while rearranging.

7. A slot machine comprising:
a slot game in which symbols which have been arranged are rearranged;
a first display including plural slot game areas on each of which the slot game is executed;
an input device for accepting a betting operation by a player; and
a controller operable to:
(a) activate slot game areas among the plural slot game areas according to the betting operation via the input device,
(b) execute a slot game at each of the slot game areas activated in (a), and
(c) rearrange, after a winning combination has been achieved in a slot game executed in (b) on one slot game area, a same symbol combination as the winning combination on another slot game area and produce a predetermined effect while rearranging,
wherein the other slot game area has mechanical reels, each of which has symbols on its outer circumferential surface.

8. A control method of a slot machine for playing a slot game in which symbols which have been arranged are rearranged, the method comprising:
(a) accepting a bet amount from a player,
(b) activate slot game areas among plural slot game areas provided on a first display according to the bet amount accepted in (a),
(c) executing a slot game on each of the slot game areas activated in (b), and
(d) rearranging, after a winning combination has been achieved in a slot game executed in (b) on one slot game area, a same symbol combination as the winning combination on another slot game area.

9. A control method of a slot machine for playing a slot game in which symbols which have been arranged are rearranged, the method comprising:
(a) accepting a bet amount from a player,
(b) activate slot game areas among plural slot game areas provided on a first display according to the bet amount accepted in (a),
(c) executing a slot game on each of the slot game areas activated in (b), and
(d) rearranging, after a winning combination has been achieved in a slot game executed in (b) on one slot game area, a same symbol combination as the winning combination on another slot game area,
wherein the other slot game area has mechanical reels, each of which has symbols on its outer circumferential surface.

10. A control method of a slot machine for playing a slot game in which symbols which have been arranged are rearranged, the method comprising:
(a) accepting a bet amount from a player,
(b) activate slot game areas among plural slot game areas provided on a first display according to the bet amount accepted in (a),
(c) executing a slot game on each of the slot game areas activated in (b), and
(d) rearranging, after a winning combination has been achieved in a slot game executed in (b) on one slot game area, a same symbol combination as the winning combination on another slot game area and producing a predetermined effect while rearranging.

11. A control method of a slot machine for playing a slot game in which symbols which have been arranged are rearranged, the method comprising:
(a) accepting a bet amount from a player,
(b) activate slot game areas among plural slot game areas provided on a first display according to the bet amount accepted in (a),
(c) executing a slot game on each of the slot game areas activated in (b), and
(d) rearranging, after a winning combination has been achieved in a slot game executed in (b) on one slot game area, a same symbol combination as the winning combination on another slot game area and producing a predetermined effect while rearranging,
wherein the other slot game area has mechanical reels, each of which has symbols on its outer circumferential surface.
